(19) United States
(12) Patent Application Publication
(10) Pub. No.: US 2003/0038843 A1
(43) Pub. Date: Feb. 27, 2003

(54) System and method for providing customer support using images over a network

(76) Inventor: Joshua Edward Smith, Barre, MA (US)

Correspondence Address: MINTZ, LEVIN, COHN, FERRIS,, GLOVSKY and POPEO, P.C., One Financial Center, Boston, MA, 02111, US

(21) Appl. No.: 10/188,195

(22) Filed: Jul. 1, 2002

Related U.S. Application Data
(60) Provisional application No. 60/315,432, filed on Aug. 28, 2001.
(60) Provisional application No. 60/302,575, filed on Jul. 2, 2001.

(51) Int. Cl. G09G 5/00

(52) U.S. Cl. 345/771

(57) ABSTRACT

The present invention relates to a system and method for providing customer service communications which allows simultaneous display of a three dimensional model. One or more customers are communicatively linked to a customer service provider. A three dimensional model is maintained by the customers and the customer service provider. A distributed synchronization algorithm coordinates the display of the model and allows all of the participants to make changes to the display.

### CROSS-REFERENCE TO RELATED APPLICATIONS

This application claims the benefit of priority to U.S. Provisional Applications Serial Nos. 60/302,575 and 60/315,432, filed Jul. 2, 2001 and Aug. 28, 2001, respectively, which are incorporated herein by reference in their entirety.

### STATEMENT REGARDING FEDERALLY SPONSORED RESEARCH

Not applicable.

### REFERENCE TO MICROFICHE APPENDIX

Not applicable.

### BACKGROUND OF THE INVENTION

The present invention is directed to a method and system for providing customer service and support over a network. In particular, it relates to a system and method wherein the customer and customer service entity simultaneously view and alter a three dimensional models displayed at respective locations.

Many industries strive to provide excellent customer service. However, current systems, such as telephone banks, impede communications between a customer and the customer service. Customers have difficulty explaining themselves or understanding explanations by the customer service provider. Since typically the customer and customer service provider are discussing a particular product, pictures of products could improve understanding and service. However, current systems do no provide easy communication of pictures. Even if both the customer and the customer service provider have an identical picture or product, they may not be able to effectively regarding that picture product, since they cannot see the product or picture in exactly the same way. Therefore, a need exists for a system which allows customers and customer service providers to effectively view and communicate with respect to pictures of products.

A typical customer service scenario involves a customer who has purchased an item from a particular manufacturer. For purposes of illustration, suppose the item is an automobile. At some point after the initial purchase, the customer may have questions about a particular malfunction in the automobile. Alternatively, he may not understand how to configure something within the automobile. At this point, the customer would be likely to call the dealership from which he purchased the car. He may try to describe a sound that he hears with reference to the location within the car from which the sound emanates. This type of troubleshooting would be aided tremendously if both parties were able to simultaneously view a three dimensional model of the vehicle. The customer could show the support representative where the suspected malfunction has occurred by using a mouse, for example, to point to the exact location. Similarly, the customer support representative may then advise the customer to perform some sort of fix for the malfunction by showing the customer where the fix could be applied on the three dimensional model of the vehicle.

A more complex scenario involving customer support could be when a manufacturer wishes to speak with a designer of a product. The designer may have provided the manufacturer with a prototype of the finished product. Suppose the manufacturer runs into problems mass producing the prototype. These mass production problems could warrant some alterations in the design of the prototype. In this situation, if the designer and the manufacturer could simultaneously view a three dimensional model of the product in a way that each could suggest changes to the product and the changes would then appear on a display unit that the other person is monitoring, the time that it would take to for the redesign to be completed would be greatly reduced. Therefore, a need exists for a system which allows the customer and the customer service provider simultaneously monitor a three dimension model. Furthermore, a need exist for a system which allows both the customer and the customer service provider to manipulate the three dimensional model in manner that is observable by both parties.

### SUMMARY OF THE INVENTION

The present invention substantially overcomes the deficiencies of the prior art by providing a system in which a three dimensional model is simultaneously rendered and displayed at two remote locations. According to an aspect of the invention, the system allows persons at either location to manipulate the three dimensional model. A distributed synchronization algorithm is used to coordinate display of the model at both locations. In this manner, both the customer and the customer service provider simultaneously view the same rendering of the model.

According to another aspect of the invention, the system is implemented by indirect connections between the two locations through a network. According to another aspect of the invention, the network may be a local area network, a wide area network, or a global network, such as the Internet or World Wide Web.

According to another aspect of the invention, the system allows multiple locations to be simultaneously linked Such that the three dimensional model is rendered and displayed at three or more locations. Additionally, persons at any of the locations my manipulate the view of the model. The distributed synchronization algorithm controls the displays at all of the locations such that all participants have the same view of the model. According to another aspect of the invention, the multiple locations are connected in a client/server system in which all manipulations of the model are transmitted to the server and then broadcast to all of the clients.

According to another aspect of the invention, the distributed synchronization algorithm estimates future manipulation of the model based upon past manipulation. Display of the model is based, in part, upon the estimates of future manipulation. According to another aspect of the invention, the distributed synchronization algorithm includes a smoothing algorithm to control movement between successive states of the model during display.

### BRIEF DESCRIPTION OF THE DRAWING

FIG. 1 illustrates a communication system according to an embodiment of the present invention.

### DETAILED DESCRIPTION

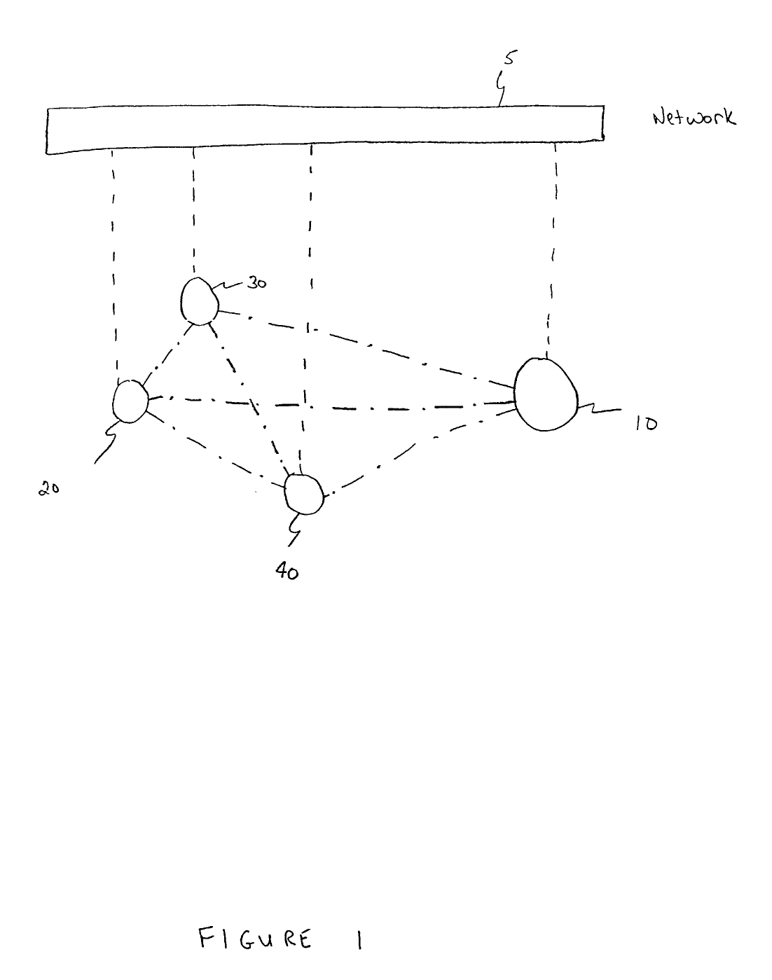

The system and method of the present invention relates to providing customer support via a computer communications network. FIG. 1 illustrates a computer communications network according to an embodiment of the present invention. The communications network includes a customer service provider computer 10 connected for communications with one or more customer computers 20, 30, 40. Of course, hardware other than a computer can be used for the customer service provider 10 or the customers 20, 30, 40. For example, a networked television, PDA, monitor, cellular phone or other device could be used. The important characteristics of the hardware are the capability for electronic communication and three dimensional display. For ease of reference, computers will be used herein to represent the possible hardware. Two different possible communication structures are illustrated in FIG. 1. The first structure, represented by the dashed lines, includes a network structure 5 connected to each of the customer service provider computer 10 and the customer computers 20, 30, 40. All communications between the computers occurs through the network. The network may be or include a local area network, a wide area network, or a global network. According to a preferred embodiment of the present invention, the network 5 is the Internet. The second structure, represented by the dashed and dotted lines, includes direct connections between all of the computers in a peer-to-peer network. Alternatively, each of the customer computers 20, 30, 40 may only be connected to the customer service provider computer 10, such that all communications between customer computers 20, 30, 40 are transmitted through the customer service provider computer 10. Preferably, the computers are personal computers with networking capability. However, the present invention is not limited to any particular type of computer.

In another embodiment, the customer and the customer service provider are linked via a central server. In an additional embodiment, the network includes a multicast-capable network to communicatively link the customer service provider and the customer. In such an embodiment, a central server, implemented using Java Servlets, provides a broadcast communications channel. Each client connects point-to-point to the server, and the server relays messages between all clients. Irrespective of the type of configuration used, the customer service representative should be communicatively linked to the at least one customer and to any additional customers seeking to obtain customer support.

Each of the computers 10, 20, 30, 40 includes appropriate program code to carryout the operations of that computer. In particular, for operation of the system of the present invention, each computer requires two specific known types of programs: a rendering program and a distributed synchronization program.

A rendering program provides three dimensional display capability. As noted above, the type of display used could be a computer monitor, television, PDA, or similar device. Preferably, the three dimensional display capability allows near real-time interaction between the entity using it and the three dimensional environment. It should also support dynamic changes to the scene, so that different participants could make changes during the customer service interaction. In a preferred embodiment, the three dimensional display capability is provided by a Java Applet deployed within a Web Page, and viewed on a Web Browser. A three dimensional model is displayed by the rendering program on each of the computers. The three dimensional model can be generated on any hardware and by any software rending program, but should be encoded in a form supported by the device upon which it will be displayed. In a preferred embodiment, the customer service representative 10 and the customer 20 display their respective three dimensional models using the same rendering program. Typically, the three dimensional model will be stored in the customer service provider computer 10. Upon commencement of communications between the customer and the customer service provider, the three dimensional model is transmitted to the customer computer 20 for display. Alternatively, the three dimensional model may be stored in the customer computer 20 and is transmitted to the customer service provider computer upon commencement of communications. The three dimensional model may also be stored at a third party location and is retrieved by both the customer computer 20 and the customer service provider computer 10. For example, when a customer contacts the automobile dealership regarding a matter, a three dimensional model of the automobile in question, including all options, could be retrieved from the manufacturer's location.

The customer service provider computer 10 and the customer computer 20 also include a distributed state synchronization program. A distributed state synchronization program is used to coordinate operations on two distinct but connected computers. The distributed state synchronization program is used to control display of the three dimensional model by the rendering program on the respective devices that they are using to view the three dimensional object. The distributed state synchronization algorithm facilitates the display of changes made to the state of the object. Changes by either the customer or customer service provider are displayed on the display devices of both the customer service provider and the customer.

Several distributed state synchronization algorithms are known and could be used in connection with the present invention. In general with these algorithms, a copy of the state of the object is retained by each entity. Changes made by one operator to the object are communicated by the distributed state synchronization algorithm to other participants in the customer service session. Those changes are then displayed on the receiving device. Communicating these changes enables each object being displayed to be updated such that each participant is, therefore, viewing the same updated object. In some embodiments, a central server might also track the state of the object. In additional embodiments, all entities participating in a customer service session, or the central server could periodically retransmit the state of the object. This periodic retransmission could also fix network transmission errors that may have occurred during the session. In a preferred embodiment, these distributed state communications strategies-would be dealt with completely automatically by the underlying software and would not require any user interaction.

As illustrated in FIG. 1, the present invention allows a single customer service provider to communicate simultaneously with multiple customers. The same three dimensional model is displayed on each of the customer computers 20, 30, 40. In this manner, multiple customers can participate in the same discussion. Of course, although not illustrated in FIG. 1, additional customer service providers could also be accommodated in the system of the present invention. The invention is not limited as to the number of participants. Irrespective of the number of entities viewing the an object, the changes made thereon should be displayed in a timely manner. In a preferred embodiment, these changes are observable by all entities participating in a particular customer service session within a few seconds. The time that it takes to display the changes is a function of the speed of the communications channel used to communicatively link the entities participating in the session. However, since only changes in the status of the object are being communicated by the distributed synchronization algorithm, transmissions are relatively short. Each computer maintains the display of the object using its own version of the model and of the rendering program.

In a preferred embodiment of the invention, each participant of the customer service session operates an interface allowing changes to the state of the object. The user interface provides the capability for customer and customer service providers to communicate graphically using the three dimensional display environment. In a preferred embodiment, the user interface allows any party to change the position, orientation, or field of view of a simulated camera. An embodiment also may provide the ability to “draw” on the object, using a mouse, for example, and to have those drawings forwarded to each participating party. Furthermore, an embodiment may allow each party to control his or her own “measuring tape” that could be stretched across the object. After the party controlling the measuring tape finished fixing the endpoints, the measuring tape in this final position could be displayed on all other parties' three dimensional display environments. In an alternate embodiment, participants would be able to view the measuring tape being stretched out by the party performing the measurement in almost real-time.

The present invention can also accommodate customers joining a customer service session after it commences. In a preferred embodiment, another client is queried by the late-joiner, in order for the late-corner to obtain a model of the object as it exists when the late-comer joins the customer service session. Preferably, the customer service provider computer 10 would be queried. However, since the status of the model is coordinated on all computers by the present invention, the late-comer can obtain the same model and status from any participant. Thus, the client who is queried might be chosen at random from all the other clients known to the late joiner. Alternatively, the entire model may be periodically broadcast by one of the participants. in this manner, not only will late-comers obtain the model, but any lost transmissions will be corrected so that synchronization is maintained.

A preferred embodiment uses a distributed state synchronization algorithm that allows any party to alter the state, for example, position, orientation, or field-of-view, of the viewpoint used by the 3D display capability. Changes coming from the various client computers are serialized by a central server computer acting as a broadcast communications channel. These changes can subsequently be sent in the order in which they are received to each customer and customer service provider participating in the session. Each customer and customer service representative observes the state of the object after the most recent changes have been applied. In addition, the distributed state synchronization algorithm may transmit predictions about future changes to the object's state. For example, the state of the object update could include a first-order derivative taken with respect to time. The derivative may predict future changes to the state of the object. For example, a message setting the yaw of the camera might also include the derivative dyaw/dtime, the rate of change in yaw with respect to time. In this manner, the system can anticipate changes and maintain close synchronization.

In a preferred embodiment, each customer and customer service uses a smoothing algorithm, such as an exponential decay interpolation, to make the transition between the current state and an updated state received over the broadcast communications channel. In this way, the changes observable by a user would be smooth, which helps to conceal network latency.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A system for providing customer service comprising:
a customer service provider display device displaying a three dimensional model;
at least one customer display device displaying the three dimensional model;
a communications link between the customer service provider display device and the at least one customer display device; and
synchronization means transmitting information over the communications link to synchronize displays of the three dimensional model on the customer service provider display device and the customer display device.

2. The system for providing customer service according to claim 1, wherein the communications link is a peer-to-peer network.

3. The system for providing customer service according to claim 1, wherein the communications link includes a global network.

4. The system for providing customer service according to claim 1, wherein the communications link includes a client/server network, the client/server network including:
means for receiving transmissions from at least one of the customer service provider display device and the at least one customer display device; and
means for transmitting the received transmissions to the customer service provider display device and the at least one customer display device.

5. The system for providing customer service according to claim 1, further comprising:
a first user interface associated with the customer service display device allowing manipulation of the display of the three dimensional model; and
a second user interface associated with the at least one customer display device allowing manipulation of the display of the three dimensional model.

6. The system for providing customer service according to claim 1, wherein the synchronization means includes means for estimating future changes in the display of the model and changing the display of the model based upon the estimated future changes.

7. The system for providing customer service according to claim 1, wherein the synchronization means includes smoothing means for changing the display of the model in a gradual manner from a first state to a second state.

8. A method for providing customer service comprising the steps of:
displaying a three dimensional model of an object on a customer service provider display device and on at least one customer display device;
changing the display of the model on one of the customer service provider display device and the at least one customer display device;
communicating the change in the display of the model to the other one of the customer service provider display device and the least one customer display device; and
changing the display of the model on the other one of the customer service provider display device and the least one customer display device based upon the communicated change.

9. The method for providing customer service according to claim 8, wherein the communicating step includes the steps of:
transmitting the change to a server; and
transmitting the change from the server to the customer service provider display device and to the least one customer display device.

10. The method for providing customer service according to claim 8, further comprising the step of:
estimating future changes to the display of the model based upon changes to the display of the model; and
wherein the communication step includes the step of communicating the estimated future changes to the other one of the customer service provider display device and the least one customer display device; and
wherein the second changing step includes the step of changing the display of the model on to the other one of the customer service provider display device and the least one customer display device based upon the estimate future changes.

11. The method for providing customer service according to claim 8, wherein the second changing step includes the step of changing the display of the model in a gradual manner from a current state to a state corresponding to the communicated change.
